(19) United States
(12) Patent Application Publication
(10) Pub. No.: US 2011/0134340 A1
(43) Pub. Date: Jun. 9, 2011

(54) Display device, method of driving the display device, and electronic device

(75) Inventors: Junichi Yamashita, Tokyo (JP); Katsuhide Uchino, Kanagawa (JP)

(73) Assignee: Sony Corporation, Tokyo (JP)

(21) Appl. No.: 12/926,206

(22) Filed: Nov. 2, 2010

(30) Foreign Application Priority Data
Dec. 7, 2009 (JP) 2009-277813

(51) Int. Cl. G09G 5/00; H04N 5/66; G09G 3/30

(52) U.S. Cl. 348/739; 345/212; 345/76; 348/E05.133

(57) ABSTRACT

A display device capable of reducing power consumption, a method of driving the display device, and an electronic device having the display device are provided. A display panel has a display region in which a plurality of display elements are arranged two-dimensionally, each display element including a first organic EL element and a pixel circuit, and a non-display region in which one adjustment pixel including a second organic EL element is disposed. A power-supply voltage adjusting circuit sets a value as a latest power-supply voltage, the value being given by adding voltage variation, which is obtained when a constant current having a magnitude necessary for light emission with white luminance (the highest gray level) of the second organic EL element is applied to the second organic EL element, to an initially set power-supply voltage. A power line drive circuit sequentially applies the set power-supply voltage to power lines.

### BACKGROUND OF THE INVENTION

1. Field of the Invention

The present invention relates to a display device including a display panel having light emitting elements therein, and a method of driving the display device. In addition, the invention relates to an electronic device having the display device.

2. Description of Related Art

Recently, a display device using a current-drive optical element as a light emitting element in a pixel, the optical element being changed in emission luminance in accordance with a value of electric current flowing into the optical element, for example, an organic EL (Electro Luminance) element, has been developed and commercialized in a field of display devices for image display. The organic EL element is a self-luminous element unlike a liquid crystal display element or the like. Therefore, a display device using the organic EL element (organic EL display device) does not need a light source (backlight) and therefore may be made small in thickness and high in luminance compared with a liquid crystal device that needs a light source. In particular, when active matrix is used as a drive method, hold-lighting of each pixel may be performed, leading to low power consumption. Therefore, the organic EL display device is expected to become a mainstream of next-generation flat panel display.

The organic EL element, which is a current-drive light emitting element, may be adjusted in gray level by controlling the amount of current flowing into the organic EL element. However, in the organic EL element, an I-V characteristic varies depending on current application time or temperature thereof. Therefore, a drive transistor which controls the amount of current flowing into the organic EL element is constantly driven in a saturated region so that even if the I-V characteristic is temporally changed, constant luminance may be obtained (see Japanese Unexamined Patent Application Publication No. 2001-60076).

### SUMMARY OF THE INVENTION

In a situation where the I-V characteristic of the organic EL element temporally varies, in order to constantly drive the drive transistor in a saturated region, a power-supply voltage needs to be set to a value high enough to prevent the drive transistor from being linearly driven when the I-V characteristic varies. For example, when an inter-terminal voltage of the organic EL element is expected to increase by about 2 V due to variation in I-V characteristic of the element, the power-supply voltage is likely to be beforehand set to a value having a margin of about 2 V. However, when the margin of the power-supply voltage is estimated and set, the power-supply voltage tends to become large compared with the minimum voltage necessary for constantly driving the drive transistor in the saturated region, and consequently power consumption has disadvantageously increased in correspondence to excessively estimated voltage.

It is desirable to provide a display device that may be controlled to be reduced in power consumption, a method of driving the display device, and an electronic device having the display device.

A display device according to an embodiment of the invention includes a display section having a display region in which a plurality of display pixels are arranged two-dimensionally, the display pixels having first light emitting elements, and a non-display region in which one or multiple adjustment pixels are arranged, each adjustment pixel having a second light emitting element. The display device further includes a drive section driving each display pixel based on a video signal, and applying a constant current to the second light emitting element. The drive section applies a power-supply voltage having a value corresponding to voltage variation in the second light emitting element to each display pixel.

An electronic device according to an embodiment of the invention includes the display device.

A method of driving a display device according to an embodiment of the invention, the display device including a display section having a display region in which a plurality of display pixels are arranged two-dimensionally, the display pixels having first light emitting elements, and a non-display region in which one or multiple adjustment pixels are arranged, each adjustment pixel having a second light emitting element, and including a drive section driving each display pixel based on a video signal and applying a constant current to the second light emitting element, includes a step of applying a power-supply voltage having a value corresponding to voltage variation in the second light emitting element to each display pixel.

In the display device, the method of driving the display device, and the electronic device according to the embodiments of the invention, a constant current is applied to the second light emitting element in the adjustment pixel, and a power-supply voltage having a value corresponding to voltage variation in the second light emitting element is applied to each display pixel. Thus, a value of power-supply voltage necessary for constant current flow may be set small compared with a case where a margin of power-supply voltage is estimated and set.

According to the display device, the method of driving the display device, and the electronic device of the embodiments of the invention, a value of power-supply voltage necessary for constant current flow may be set small compared with a case where a margin of power-supply voltage is estimated and set. Thus, power consumption may be controlled to be low.

Other and further objects, features and advantages of the invention will appear more fully from the following description.

### BRIEF DESCRIPTION OF THE DRAWINGS

FIG. 1 is a schematic diagram showing an example of a configuration of a display device according to a first embodiment of the invention.

FIG. 2 is a schematic diagram showing an example of a configuration of a sub pixel in a display region.

FIG. 3 is a schematic diagram showing an example of a configuration of an adjustment pixel in a non-display region.

FIG. 4 is a top diagram showing an example of a configuration of a display panel in FIG. 1.

FIG. 5 is a schematic diagram showing an example of a configuration of a power line drive circuit.

FIG. 6 is a schematic diagram showing an example of a configuration of a power-supply voltage adjusting circuit.

FIG. 7 is a relationship diagram showing an example of a relationship between a saturated region of a drive transistor and a gray level

FIG. 8 is a relationship diagram showing an example of a relationship between a poser-supply voltage, a voltage of an organic EL element, and a drain-to-source voltage of a drive transistor.

FIG. 9 is a relationship diagram showing an example of a relationship between panel temperature and a voltage of an organic EL element.

FIG. 10 is a relationship diagram showing an example of a relationship between time of current application to an organic EL element and voltage variation in the organic EL element.

FIG. 11 is a schematic diagram showing another example of a configuration of the display device of FIG. 1.

FIG. 12 is a schematic diagram showing an example of a configuration of a sub pixel in a non-display region in FIG. 11.

FIG. 13 is a schematic diagram showing an example of a configuration of a display device according to a second embodiment of the invention.

FIG. 14 is a schematic diagram showing an example of a configuration of a sub pixel in a non-display region in FIG. 13.

FIG. 15 is a schematic diagram schematically showing an aspect where a display pixel and an adjustment pixel are connected to common WSL and common PSL.

FIG. 16 is a schematic diagram showing another example of a configuration of a sub pixel in a display region

FIG. 17 is a schematic diagram showing another example of a configuration of an adjustment pixel in a non-display region.

FIG. 18 is a perspective diagram showing appearance of application example 1 of the display device according to each of the embodiments.

FIGS. 19A and 19B are perspective diagrams, where FIG. 19A shows appearance of application example 2 as viewed from a surface side, and FIG. 19B shows appearance thereof as viewed from a back side.

FIG. 20 is a perspective diagram showing appearance of application example 3.

FIG. 21 is a perspective diagram showing appearance of application example 4.

FIGS. 22A to 22G are diagrams of application example 5, where FIG. 22A is a front diagram of the example 5 in an opened state, FIG. 22B is a side diagram thereof, FIG. 22C is a front diagram thereof in a closed state, FIG. 22D is a left side diagram thereof, FIG. 22E is a right side diagram thereof, FIG. 22F is a top diagram thereof, and FIG. 22G is a bottom diagram thereof.

### DETAILED DESCRIPTION OF THE PREFERRED EMBODIMENTS

Hereinafter, a preferred embodiment of the invention will be described in detail with reference to drawings. Description is made in the following sequence.

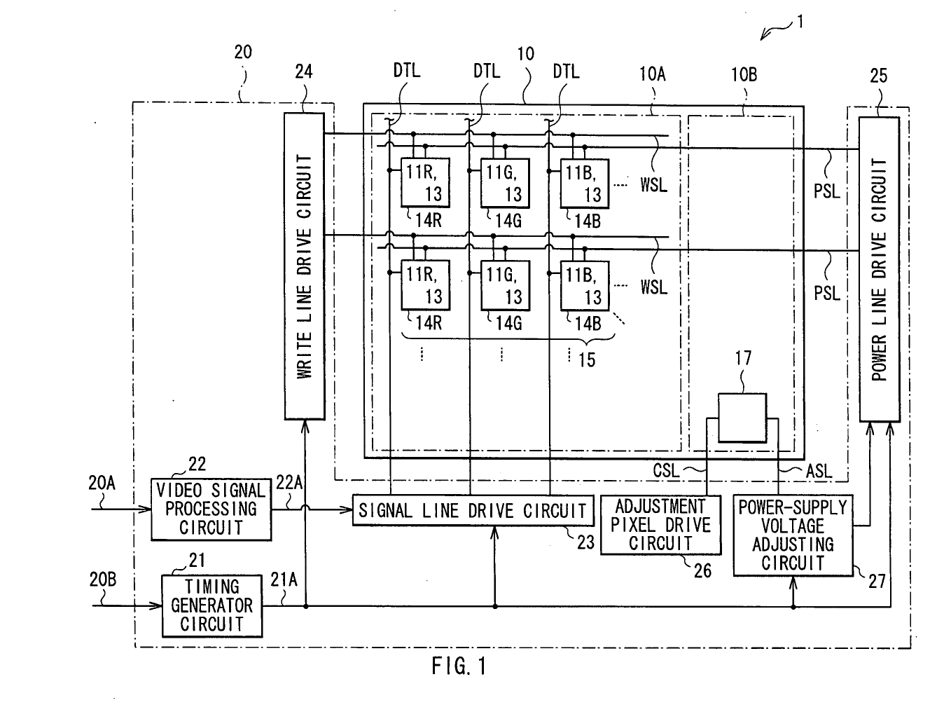

1. First embodiment (FIGS. 1 to 10)

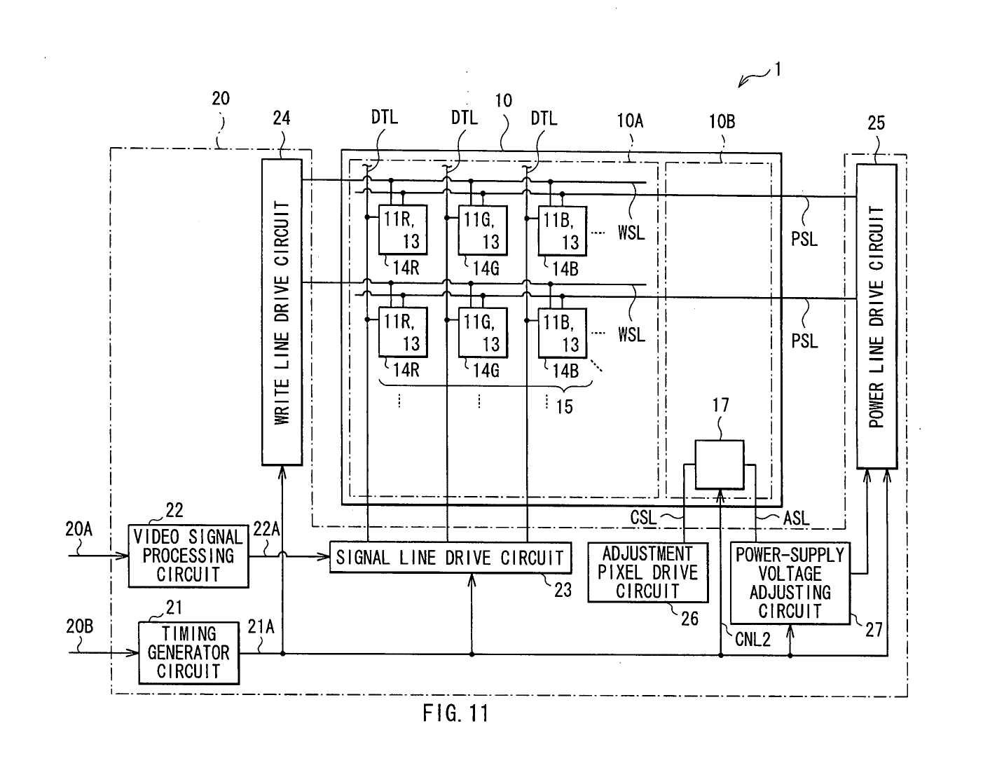

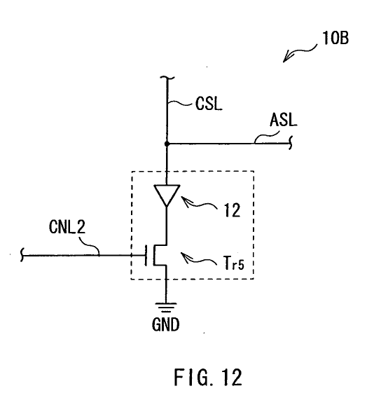

2. Modification of the first embodiment (FIGS. 11 and 12)

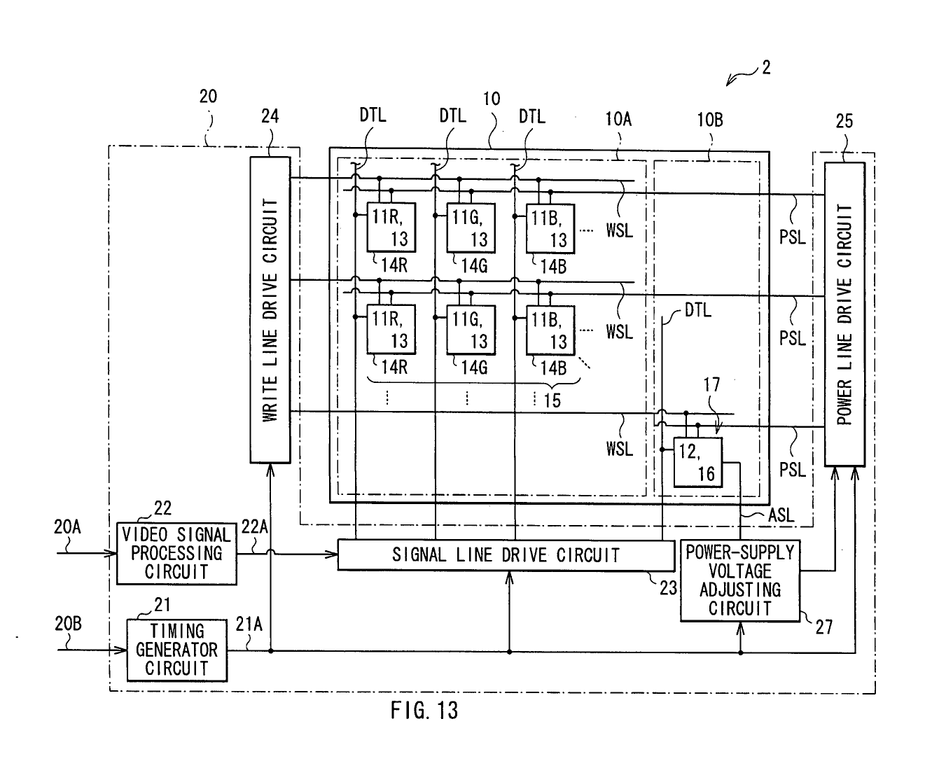

3. Second embodiment (FIGS. 13 to 15)

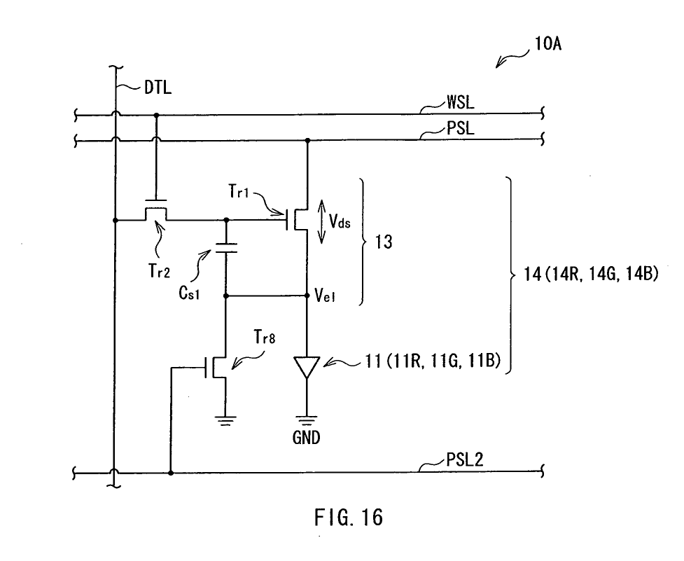

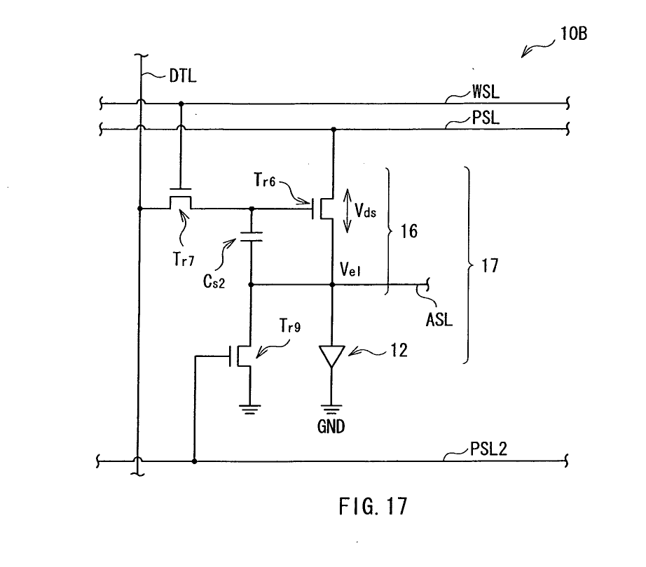

4. Modification of the second embodiment (FIGS. 16 and 17)

5. Modification common to the first and second embodiments (no figure)

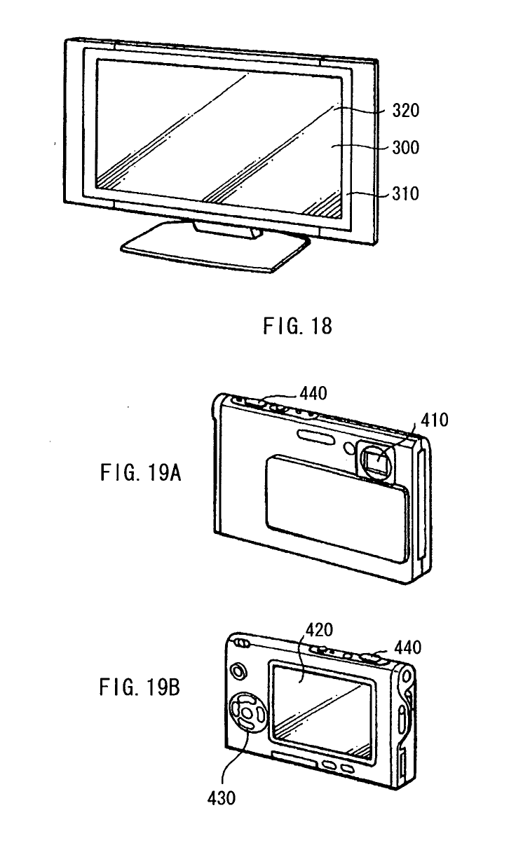

6. Application examples (FIGS. 18 to 22G)

### First Embodiment

### Schematic Configuration of Display Device 1

FIG. 1 shows a schematic configuration of a display device 1 according to a first embodiment of the invention. The display device 1 includes a display panel 10 (display section) and a drive circuit 20 (drive section) that drives the display panel 10.

The display panel 10 has a display region 10A having a plurality of organic EL elements 11R, 11G and 11B (first light emitting elements) arranged two-dimensionally therein. Hereinafter, a term “organic EL element 11” is appropriately used as a collective term of the organic EL elements 11R, 11G and 11B. The display panel 10 further has a non-display region 10B having an organic EL element 12 (second light emitting element) disposed therein. The organic EL element 12 emits light of the same emission color as that of one of the organic EL elements 11R, 11G and 11B, or emits light of a color different from emission colors of the organic EL elements 11R, 11G and 11B (for example, white light).

The drive circuit 20 has a timing generator circuit 21, a video signal processing circuit 22, a signal line drive circuit 23, a write line drive circuit 24, a power line drive circuit 25, an adjustment pixel drive circuit 26, and a power-supply voltage adjusting circuit 27.

Display Pixel 15

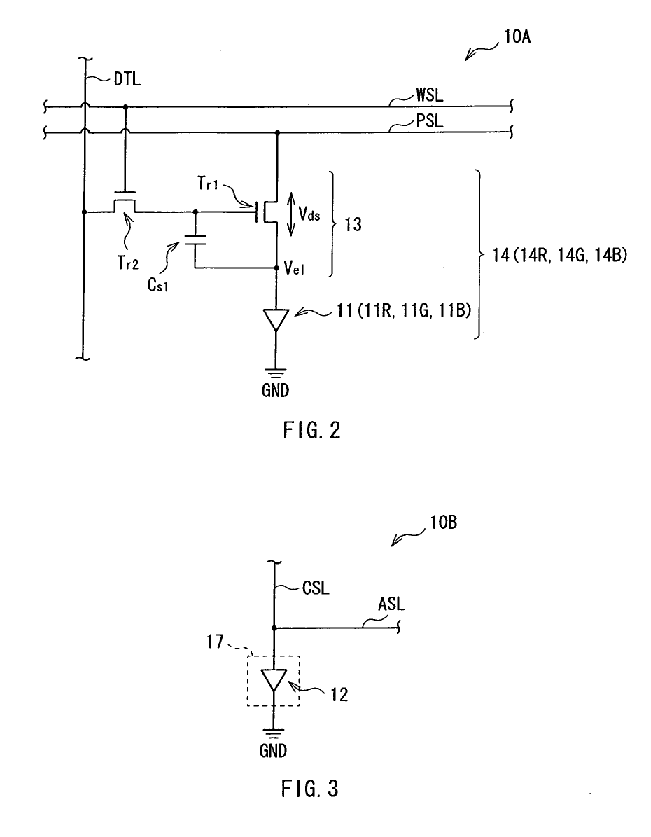

FIG. 2 shows an example of a circuit configuration in the display region 10A. In the display region 10A, a plurality of pixel circuits 13 are coupled with the organic EL elements 11 and two-dimensionally arranged. In the embodiment, a pair of an organic EL element 11 and a pixel circuit 13 configures one sub pixel 14. More specifically, as shown in FIG. 1, a pair of an organic EL element 11R and a pixel circuit 13 configures one sub pixel 14R, a pair of an organic EL element 11G and a pixel circuit 13 configures one sub pixel 14G, and a pair of an organic EL element 11B and a pixel circuit 13 configures one sub pixel 14B. Furthermore, three sub pixels 14R, 14G and 14B adjacent to one another configure one pixel (display pixel 15).

Each pixel circuit 13 is configured of, for example, a drive transistor Tr₁ (first transistor), a write transistor Tr₂ (second transistor), and a capacitance Cₛ₁, and thus has a configuration of 2Tr1C. The drive transistor Tr₁ and the write transistor Tr₂ are, for example, formed of an n-channel MOS thin-film transistor (TFT) each. The drive transistor Tr₁ or the write transistor Tr₂ may be, for example, a p-channel MOS TFT.

In the display region 10A, a plurality of signal lines DTL are disposed in a column direction, and a plurality of write lines WSL and a plurality of power lines PSL (members for supplying a power-supply voltage) are disposed in a row direction, respectively. One organic EL element 11 is provided near each of intersections between the signal lines DTL and the write lines WSL. Each signal line DTL is connected to an output end (not shown) of the signal line drive circuit 23 and one of drain and source electrodes (not shown) of the write transistor Tr₂. Each write line WSL is connected to an output end (not shown) of the write line drive circuit 24 and a gate electrode (not shown) of the write transistor Tr₂. Each power line PSL is connected to an output end (not shown) of the power line drive circuit 25 and one of drain and source electrodes (not shown) of the drive transistor Tr₁. One of the drain and source electrodes (not shown), being not connected to the signal line DTL, of the write transistor Tr₂ is connected to a gate electrode (not shown) of the drive transistor Tr₁ and one end of the capacitance Cₛ₁. One of the drain and source electrodes (not shown), being not connected to the power line PSL, of the drive transistor Tr₁ and the other end of the capacitance Cₛ₁ are connected to an anode electrode (not shown) of the organic EL element 11. A cathode electrode (not shown) of the organic EL element 11 is connected to, for example, a ground line GND.

Adjustment Pixel 17

FIG. 3 shows an example of a circuit configuration in the non-display region 10B. In the non-display region 10B, an adjustment pixel 17 is provided. The adjustment pixel 17 includes, for example, one organic EL element 12 as shown in FIG. 3. An anode electrode (not shown) of the organic EL element 12 is connected to one end of a current signal line CSL and one end of an anode signal line ASL. A cathode electrode (not shown) of the organic EL element 12 is connected to, for example, the ground line GND.

Top Configuration of Display Panel 10

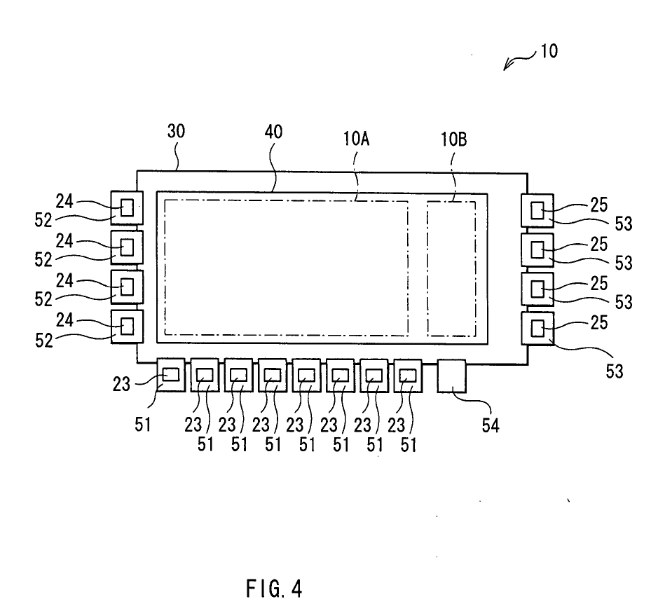

FIG. 4 shows an example of a top configuration of the display panel 10. The display panel 10 is, for example, in a configuration where a drive panel 30 is attached to a seal panel 40 via a sealing layer (not shown).

While not shown in FIG. 4, the drive panel 30 has the plurality of organic EL elements 11 arranged two-dimensionally and the plurality of pixel circuits 13 adjacent to the organic EL elements 11 in the display region 10A. Furthermore, while not shown in FIG. 4, the drive panel 30 has one organic EL element 12 in the non-display region 10B.

One side (long side) of the drive panel 30 is, for example, attached with a plurality of video signal supply TAB 51 and a signal input/output TCP 54 as shown in FIG. 4. Another side (short side) of the drive panel 30 is, for example, attached with scan signal supply TAB 52. A short side of the drive panel 30, which is different from the side attached with the scan signal supply TAB 52, is, for example, attached with power-supply voltage supply TAB 53. The video signal supply TAB 51 is configured such that IC including the signal line drive circuit 23 is interconnected with an air gap on an opening of a film-like wiring substrate. The scan signal supply TAB 52 is configured such that IC including the write line drive circuit 24 is interconnected with an air gap on an opening of a film-like wiring substrate. The power-supply voltage supply TAB 53 is configured such that IC including the power line drive circuit 25 is interconnected with an air gap on an opening of a film-like wiring substrate. The power-supply voltage supply TAB 53 is connected to an output end (not shown) of the power-supply voltage adjusting circuit 27. The signal input/output TCP 54 is connected to an input end (not shown) of the power-supply voltage adjusting circuit 27. The signal line drive circuit 23, the write line drive circuit 24, and the power line drive circuit 25 may not be formed on TAB, and, for example, may be formed on the drive panel 30.

The seal panel 40 has, for example, a seal substrate (not shown) for sealing the organic EL elements 11 and 12, and a color filter (not shown). The color filter is provided in a region through which light of the organic EL element 11 may transmit of a surface of the seal substrate. The color filter has, for example, a red filter, a green filter, and a blue filter (not shown) in correspondence to the organic EL elements 11R, 11G and 11B, respectively.

Drive Circuit 20

Next, circuits in the drive circuit 20 are described with reference to FIG. 1. The timing generator circuit 21 controls such that the video signal processing circuit 22, the signal line drive circuit 23, the write line drive circuit 24, the power line drive circuit 25, the adjustment pixel drive circuit 26, and the power-supply voltage adjusting circuit 27 operate in conjunction with one another.

For example, the timing generator circuit 21 outputs a control signal 21A to each of the circuits in response to (in synchronization with) a synchronizing signal 20B input from the outside. For example, the timing generator circuit 21 is formed on a control circuit substrate (not shown), which is separated from the display panel 10, together with the video signal processing circuit 22 and the power-supply voltage adjusting circuit 27.

For example, the video signal processing circuit 22 corrects a digital video signal 20A input from the outside in response to (in synchronization with) a synchronizing signal 20B input from the outside, and converts such a corrected video signal into an analog signal, and outputs the analog signal as an analog video signal 22A to the signal line drive circuit 23.

The signal line drive circuit 23 outputs the analog video signal 22A input from the video signal processing circuit 22 in response to (in synchronization with) an input control signal 21A so that each display pixel 15 is driven. In other words, the signal line drive circuit 23 writes the analog video signal 22A (signal voltage) into a gate of the drive transistor Tr₁ in each display pixel 15. The signal line drive circuit 23 outputs the video signal 22A which has been corrected by the video signal processing circuit 22 to a signal line DTL corresponding to each display pixel 15. The signal line drive circuit 23 is, for example, provided on the video signal supply TAB 51 attached to one side (long side) of the drive panel 30 as shown in FIG. 4.

The write line drive circuit 24 sequentially selects one write line WSL from among the plurality of write lines WSL in response to (in synchronization with) an input control signal 21A. The write line drive circuit 24 is, for example, provided on the scan signal supply TAB 52 attached to the other side (short side) of the drive panel 30 as shown in FIG. 4.

The power line drive circuit 25 sequentially applies a power-supply voltage having a value corresponding to a value of a power-supply voltage V_{cc} output from the power-supply voltage adjusting circuit 27 to the plurality of power lines PSL in response to (in synchronization with) an input control signal 21A so that emission or non-emission of light from the organic EL element 11 are controlled.

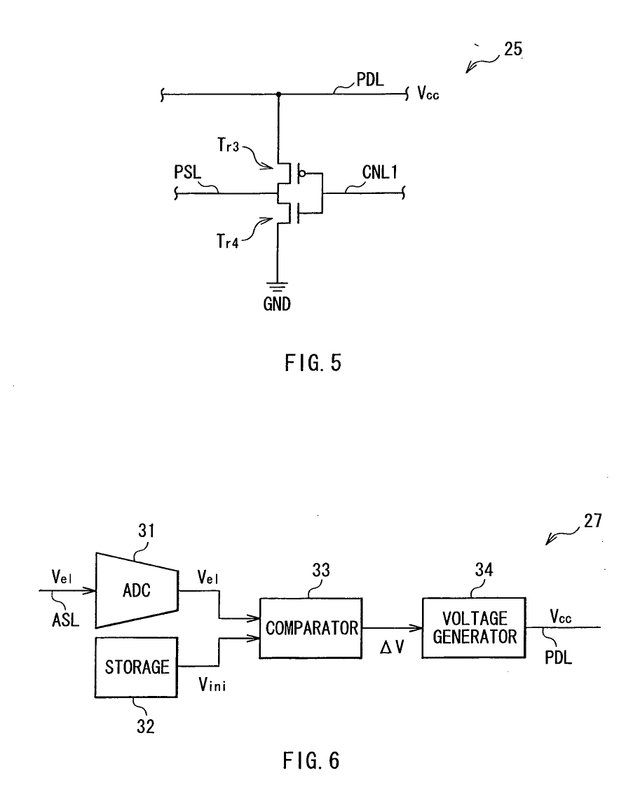

For example, the power line drive circuit 25 has switching transistors Tr₃ and Tr₄ connected in series to each other between a power-supply voltage transmission line PDL provided for each power line PSL and the ground line GND as shown in FIG. 5. The power line PSL is connected to a connection between the transistors Tr₃ and Tr₄, and both gates of the transistors Tr₃ and Tr₄ are connected to a control line CNL₁. The control line CNL₁ is input with a control signal for applying the power-supply voltage V_{cc} to the power line PSL only for a desired period.

The adjustment pixel drive circuit 26 has a current source (not shown) outputting a current having a constant value (constant current) to the organic EL element 12. For example, the adjustment pixel drive circuit 26 applies a constant current having a magnitude necessary for light emission of the organic EL element 12 with white luminance (for example, the highest gray level) to the organic EL element 12. An output end of the adjustment pixel drive circuit 26 (power-supply line) is connected to the current signal line CSL. The adjustment pixel drive circuit 26 outputs a current having a constant value (constant current) to the current signal line CSL in response to (in synchronization with) an input control signal 21A so that the adjustment pixel 17 is driven.

The power-supply voltage adjusting circuit 27 generates a power-supply voltage having a value corresponding to voltage variation in the organic EL element 12 in the adjustment pixel 17 in response to (in synchronization with) an input control signal 21A. For example, the power-supply voltage adjusting circuit 27 has ADC (Analog Digital Converter) 31, a storage 32, a comparator 33, and a voltage generator 34 as shown in FIG. 6. An input end (not shown) of the ADC 31 is connected to the anode signal line ASL as shown in FIGS. 3 and 6, and an output end (not shown) of the ADC 31 and an output end (not shown) of the storage 32 are connected to input ends (not shown) of the comparator 33. An output end (not shown) of the comparator 33 is connected to an input end (not shown) of the voltage generator 34, and an output end (not shown) of the voltage generator 34 is connected to the power-supply voltage transmission line PDL.

The ADC 31 converts an input analog signal (anode voltage Vₑₗ) into a digital signal. The storage 32 stores an initial voltage Vᵢₙᵢ (=Vₑₗ(0)) (reference voltage) of the organic EL element 12 therein. The comparator 33 compares a digital signal (anode voltage Vₑₗ) input from the ADC 31 to the initial voltage Vᵢₙᵢ read from the storage 32, and thus derives voltage variation ΔV in the organic EL element 12 in the adjustment pixel 17. Specifically, the comparator 33 obtains a difference between the anode voltage Vₑₗ and the initial voltage Vᵢₙᵢ, and thus derives voltage variation ΔV (=Vₑₗ-Vᵢₙᵢ) of the anode voltage Vₑₗ.

The voltage generator 34 uses the voltage variation ΔV to derive a value of a power-supply voltage to be applied to each display element 15, and applies a power-supply voltage having such a derived value to each display pixel 15 (each power-supply voltage transmission line PDL). Specifically, the voltage generator 34 uses the voltage variation ΔV to derive a power-supply voltage value necessary for driving the drive transistor Tr₁ in a saturated region, and applies a power-supply voltage V_{cc} having the derived value to each display pixel 15 (each power-supply voltage transmission line PDL). The power-supply voltage V_{cc} preferably has a value as a minimum necessary voltage value for driving the drive transistor Tr₁ in the saturated region. In other words, the voltage generator 34 applies a power-supply voltage having a value corresponding to variation in voltage value monitored by the ADC 31 during light emission to each display pixel 15.

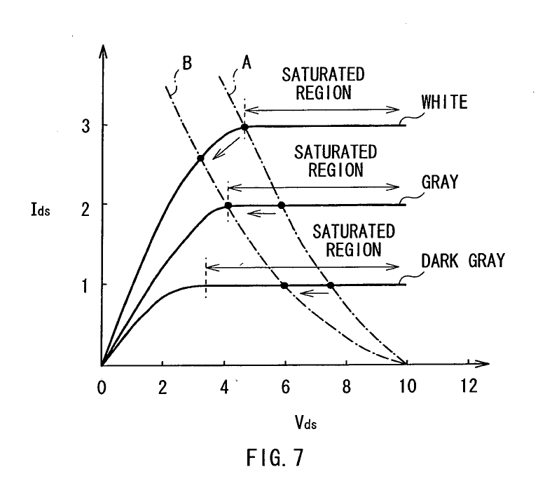

For example, the saturated region refers to a region where current I_{ds} flowing into the organic EL element 11 is constant regardless of a value of a drain-to-source voltage V_{ds} of the drive transistor Tr₁ as shown in FIG. 7. In the saturated region, the current I_{ds} may not be completely constant regardless of the value of the drain-to-source voltage V_{ds} of the drive transistor Tr₁. The saturated region still includes a region where change rate of the current I_{ds} is gradual compared with a linear region where the current I_{ds} greatly varies depending on a value of the drain-to-source voltage V_{ds} of the drive transistor Tr₁.

Operation of Display Device 1

Next, an example of operation of the display device 1 according to the embodiment is described. First, a video signal 20A and a synchronizing signal 20B are input from the outside to the display device 1. Then, the timing generator circuit 21 outputs a control signal 21A to each of the circuits in the drive circuit 20, and each circuit in the drive circuit 20 operates according to an instruction of the control signal 21A. Specifically, the video signal processing circuit 22 generates a video signal 22A. Then, the signal line drive circuit 23 outputs the generated video signal 22A to each signal line DTL, and concurrently the write line drive circuit 24 sequentially selects one write line WSL from the plurality of write lines WSL. Furthermore, the adjustment pixel drive circuit 26 outputs a constant current to the current signal line CSL, and the output constant current flows into the organic EL element 12 in the adjustment pixel 17. A power-supply voltage having a value corresponding to voltage variation in the organic EL element 12 is output from the power-supply voltage adjusting circuit 27 to the power-supply voltage transmission line PDL, and the power-supply voltage output to the power-supply voltage transmission line PDL is then sequentially applied to the plurality of power-supply lines PSL by the power-supply line drive circuit 25. Thus, the display pixels 15 and the adjustment pixel 17 are driven, and thus a video image is displayed on the display region 10A.

Advantage of Display Device 1

Next, advantage of display device 1 according to the embodiment is described. As shown in FIG. 7, a lower end of the saturated region varies depending on gray levels. As a gray level becomes lower, the lower end of the saturated region shifts to a side of a smaller drain-to-source voltage V_{ds} of the drive transistor Tr₁. Therefore, when an initial I-V characteristic of the organic EL element 11 is expressed as a curve A in the figure, an operating point (black circle) tends to be closer to the lower end of the saturated region with increase in gray level, and accordingly a margin between the operating point (black circle) and the lower end of the saturated region tends to be reduced. Therefore, when the I-V characteristic of the organic EL element 11 shifts into a curve B in the figure, the operating point is still in the saturated region in intermediate and low gray levels, but the operating point is in the linear region in a high gray level.

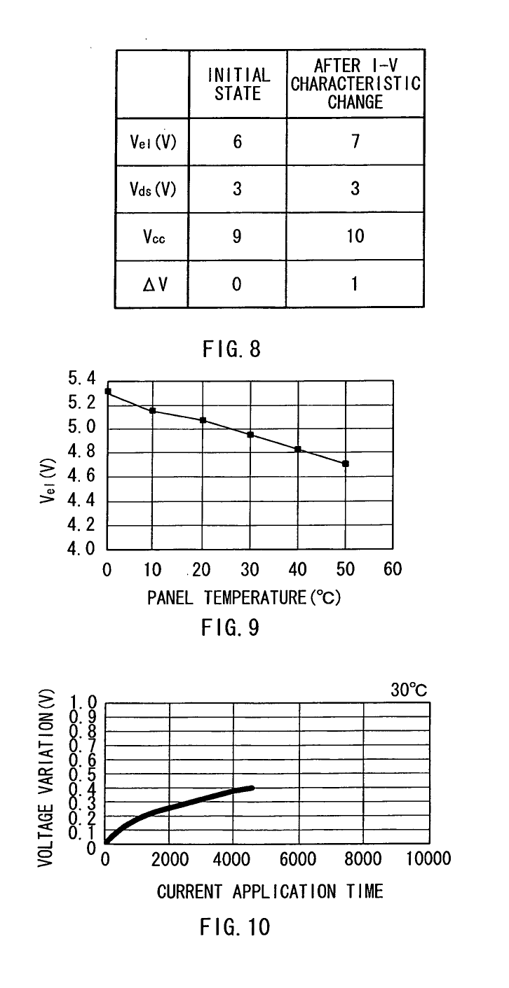

It is assumed that a value of the power-supply voltage V_{cc} is estimated and set (with a margin) such that the operating point is in the saturated region in all gray levels. Thus, even if a video signal 22A (video signal for one field) applied to each display pixel 15 includes a value corresponding to a high gray level (for example, see FIG. 8), the drive transistor Tr₁ may be driven in the saturated region in any of the display pixels 15. However, in this case, the power-supply voltage V_{cc} becomes large compared with the minimum necessary power-supply voltage for constantly driving the drive transistor Tr₁ in the saturated region. Particularly, difference between the set power-supply voltage V_{cc} and the minimum necessary power-supply voltage for constantly driving the drive transistor Tr₁ in the saturated region is increased in the intermediate and low gray levels. Consequently, power consumption increases in correspondence to the excessively estimated voltage.

In the embodiment, the drive transistor Tr₁ in each display pixel 15 is set with a value of the power-supply voltage V_{cc} necessary for the operating point to constantly stay in the saturated region (or a value of the minimum power-supply voltage V_{cc} necessary for the operating point to constantly stay in the saturated region). For example, when a video signal corresponding to white luminance (the highest gray level) is applied to one display pixel 15, a value of the power-supply voltage V_{cc} is set such that the operating point is located at a lower end of the saturated region in a drive transistor Tr₁ in the display pixel 15. For example, a value (V_{cc}(0)+ΔV) given by adding voltage variation ΔV, which is obtained when a constant current having a magnitude necessary for light emission of the organic EL element 12 with white luminance (the highest gray level) is applied to the organic EL element 12, to an initially set power-supply voltage V_{cc}(0) (=Vₑₗ(0)+V_{ds}(0)) is set as a value of a latest power-supply voltage V_{cc}. Vₑₗ(0) is an initial voltage V_{c1} of the organic EL element 11, and V_{ds}(0) is an initial drain-to-source voltage V_{ds} of the drive transistor Tr₁.

For example, as shown in FIG. 8, it is assumed that initially, an anode voltage Vₑₗ (=Vₑₗ(0)) of the organic EL element 11 is 6 V, a drain-to-source voltage V_{ds} (=V_{ds}(0)) of the drive transistor Tr₁ is 3 V, and a power-supply voltage V_{cc} (=V_{cc}(0)) is 9V. It is then assumed that an I-V characteristic of the organic EL element 11 is changed, so that the anode voltage Vₑₗ of the organic EL element 11 becomes 7 V. In such a situation, in the embodiment, for example, ΔV is not simply set to an estimated value (for example, 2 V), but set such that when a video signal corresponding to white luminance (the highest gray level) is applied to one display pixel 15, the operating point is located at the lower end of the saturated region for a drive transistor Tr₁ in the display pixel 15. For example, a value of voltage variation ΔV (for example, 1 V) which is obtained when a constant current having a magnitude necessary for light emission of the organic EL element 12 with white luminance (the highest gray level) is set as a value of ΔV. Then, ΔV is added to V_{cc}(0), and 10 V is set as a new value of the power-supply voltage V_{cc}. In this way, in the embodiment, a value of the power-supply voltage V_{cc} may be reduced compared with a case where a margin of the power-supply voltage is estimated and set. Consequently, power consumption may be controlled to be low.

The I-V characteristic of the organic EL element 11 shifts into the curve B as shown in FIG. 7 which occurs, for example, in the case that panel temperature is lowered (see FIG. 9) or time of current application into the organic EL element 11 is increased (see FIG. 10). Therefore, a drive method according to the embodiment is particularly effective when panel temperature is lowered, or time of current application into the organic EL element 11 is increased.

### Modification of First Embodiment

In the embodiment, the adjustment pixel drive circuit 26 may intermittently apply a constant current to the organic EL element 12 so that a light emission period of the organic EL element 12 is equal to a light emission period of an organic EL element 11 in one display pixel 15 (specified pixel) of the plurality of display pixels 15. For example, as shown in FIG. 12, it is acceptable that the adjustment pixel 17 has a transistor Tr₅ (switching element) connected in series to the second light emitting element, and the timing generator circuit 21 turns on or off the transistor Tr₅ so that a light emission period of the organic EL element 12 is equal to a light emission period of an organic EL element 11 in a display pixel 15 as a specified pixel. A control signal for driving the transistor Tr₅ to be turned on or off is input via a control line CNL₂ connected to a gate of the transistor Tr₅.

### Second Embodiment

Schematic configuration of display device 2

FIG. 13 shows a schematic configuration of a display device 2 according to a second embodiment of the invention. The display device 2 is different in configuration from the display device 1 according to the first embodiment in that the adjustment pixel drive circuit 26 is eliminated, the adjustment pixel 17 is connected with the signal line DTL and the power-supply line PSL, and a pixel circuit 16 is provided in the adjustment pixel 17. Hereinafter, different points from the first embodiment are mainly described, and description of points common to the first embodiment is appropriately omitted.

Adjustment Pixel 17

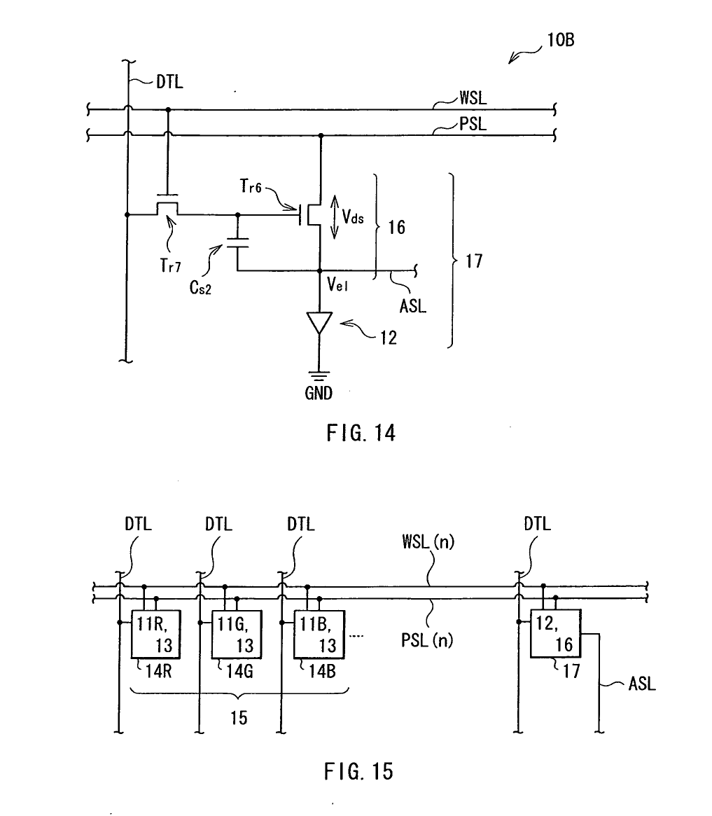

FIG. 14 shows an example of a circuit configuration in the non-display region 10B. One pixel circuit 16 is coupled with the organic EL element 12 in the non-display region 10B. In the embodiment, a pair of the organic EL element 12 and the pixel circuit 16 configures one pixel (adjustment pixel 17).

The pixel circuit 16 has the same configuration as the pixel circuit 13. Specifically, the pixel circuit 16 is configured of a drive transistor Tr₆, a write transistor Tr₇, and a capacitance Cₛ₂, and thus has a configuration of 2Tr1C. The drive transistor Tr₆ and the write transistor Tr₇ are, for example, formed of an n-channel MOS TFT each. The drive transistor Tr₆ or the write transistor Tr₇ may be, for example, a p-channel MOS TFT.

In the non-display region 10B, one signal line DTL is disposed in a column direction, and one write line WSL and one power line PSL are disposed in a row direction, respectively. The organic EL element 12 is provided near an intersection between the signal line DTL and the write line WSL. The signal line DTL is connected to an output end (not shown) of the signal line drive circuit 23 and a drain electrode (not shown) of the write transistor Tr₇. The write line WSL is connected to an output end (not shown) of the write line drive circuit 24 and a gate electrode (not shown) of the write transistor Tr₇. Among the plurality of write lines WSL, a write line WSL connected to the adjustment pixel 17 is, for example, not connected to the display pixel 15. Each power line PSL is connected to an output end (not shown) of the power line drive circuit 25 and a drain electrode (not shown) of the drive transistor Tr₆. Among the plurality of power lines PSL, a power line PSL connected to the adjustment pixel 17 is, for example, not connected to the display pixel 15. A source electrode (not shown) of the write transistor Tr₇ is connected to a gate electrode (not shown) of the drive transistor Tr₆ and one end of the capacitance Cₛ₂. A source electrode (not shown) of the drive transistor Tr₆ and the other end of the capacitance Cₛ₂ are connected to an anode electrode (not shown) of the organic EL element 12. A cathode electrode (not shown) of the organic EL element 12 is connected to, for example, a ground line GND. The anode electrode of the organic EL element 12 is connected with one end of an anode signal line ASL. The other end of the anode signal line ASL is connected to the power-supply voltage adjusting circuit 27.

For example, the timing generator circuit 21 operates such that the write transistors Tr₂ and Tr₇ are turned on/off at the same timing and the drive transistors Tr₁ and Tr₆ are turned on/off at the same timing in a specified pixel and the adjustment pixel 17 so that a light emission period of the organic EL element 12 is the same as a light emission period of an organic EL element 11 in a pixel element 15 as the specified pixel. For example, the timing generator circuit 21 may apply the same control pulse to the write transistors Tr₂ and Tr₇, and may apply the same control pulse to the drive transistors Tr₁ and Tr₆ in the specified pixel and the adjustment pixel 17.

The signal line drive circuit 23 outputs a video signal 22A (fixed signal) having a fixed voltage value to a signal line DTL corresponding to the adjustment pixel 17. For example, the signal line drive circuit 23 outputs a video signal 22A (fixed signal) corresponding to white luminance (the highest gray level) to the signal line DTL corresponding to the adjustment pixel 17.

Even in the embodiment, when a video signal corresponding to white luminance (the highest gray level) is applied to one display pixel 15, a value of a power-supply voltage V_{cc} is set such that an operating point is located at a lower end of a saturated region in a drive transistor Tr₁ in the display pixel 15. In other words, a value (V_{cc}(0)+ΔV) given by adding voltage variation ΔV which is obtained when a constant current having a magnitude necessary for light emission of the organic EL element 12 with white luminance (the highest gray level) is applied to the organic EL element 12 to an initially set power-supply voltage V_{cc}(0) (=Vₑₗ(0)+V_{ds}(0)) is set as a value of a latest power-supply voltage V_{cc}. Thus, a value of the power-supply voltage V_{cc} may be reduced compared with a case where a margin of the power-supply voltage is estimated and set. Consequently, power consumption may be controlled to be low. In addition, a drive method according to the embodiment is also particularly effective when panel temperature is lowered, or time of current application into the organic EL element 11 is increased.

### Modification of Second Embodiment

While the second embodiment has been described with a case, as an example, that a write line WSL connected to the adjustment pixel 17 among the write lines WSL and a power line PSL connected to the adjustment pixel 17 are not connected to a display pixel 15, the lines may be connected to a display pixel 15. For example, as shown in FIG. 15, a last write line WSL(n) of the plurality of write lines WSL and a last power line PSL(n) of the plurality of power lines PSL may be connected to a display pixel 15 and to the adjustment pixel 17.

Moreover, while the second embodiment has been described with a case, as an example, that the plurality of power lines PSL are electrically separated from one another, and the power lines PSL are sequentially scanned by the power line drive circuit 25, a fixed voltage may be applied to all the power lines PSL. In this case, an output end of the power-supply voltage adjusting circuit 27 may be directly connected to the power lines PSL. However, in such a case, output ends of the power line drive circuit 25 may be separated from the power lines PSL, and an internal configuration of the pixel circuit 13 or 16 may be made different from that exemplified above. For example, as shown in FIG. 16 or 17, the pixel circuit 13 or 16 may have a configuration of 3Tr1C having an initialization transistor Tr₈ or Tr₉ between a connection between the capacitance Cs₁ (Cs₂) and the organic EL element 11 (12) and the ground line GND. In such a configuration, for example, a gate of the transistor Tr₈ or Tr₉ may be connected with an output end of the power line drive circuit 25 via a power line PSL2.

### Modification Common to First and Second Embodiments

While only one adjustment pixel 17 has been provided in the embodiments, a plurality of adjustment pixels 17 may be provided. Moreover, while the adjustment pixel 17 has been provided in the non-display region 10B, the pixel may be provided in the display region 10A.

Moreover, while the power-supply voltage V_{cc} has been adjusted in the embodiments, a cathode voltage of the organic EL element 11 may be adjusted.

### Application Examples

Hereinafter, application examples of the display devices 1 and 2 described in the embodiments and the modifications thereof are described. The display devices 1 and 2 according to the embodiments and the like may be applied to display devices of electronic devices in any field, including a television apparatus, a digital camera, a notebook personal computer, a mobile terminal such as mobile phone, and a video camera, for displaying a still or moving image based on an externally-input or internally-generated video signal.

### Application Example 1

FIG. 18 shows appearance of a television apparatus using the display device 1 or 2 according to the embodiments and the like. The television apparatus has, for example, an image display screen 300 including a front panel 310 and filter glass 320, and the image display screen 300 is configured of the display device 1 or 2 according to the embodiments and the like.

### Application Example 2

FIGS. 19A and 19B show appearance of a digital camera using the display device 1 or 2 according to the embodiments and the like. The digital camera has, for example, a light emitting section for flash 410, a display 420, a menu switch 430 and a shutter button 440, and the display 420 is configured of the display device 1 or 2 according to the embodiments and the like.

### Application Example 3

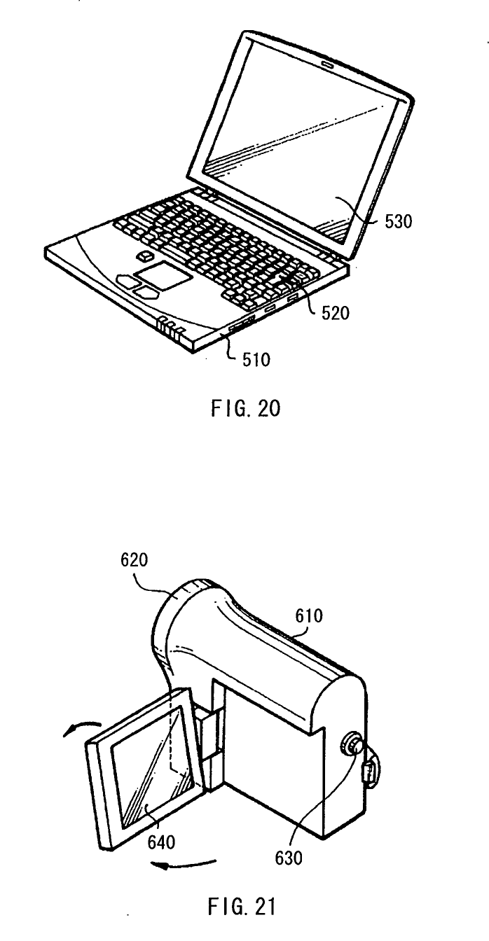

FIG. 20 shows appearance of a notebook personal computer using the display device 1 or 2 according to the embodiments and the like. The notebook personal computer has, for example, a body 510, a keyboard 520 for input operation of letters and the like, and a display 530 for displaying images, and the display 530 is configured of the display device 1 or 2 according to the embodiments and the like.

### Application Example 4

FIG. 21 shows appearance of a video camera using the display device 1 or 2 according to the embodiments and the like. The video camera has, for example, a body 610, an object-shooting lens 620 provided on a front side-face of the body 610, a start/stop switch 630 for shooting, and a display 640. The display 640 is configured of the display device 1 or 2 according to the embodiments and the like.

### Application Example 5

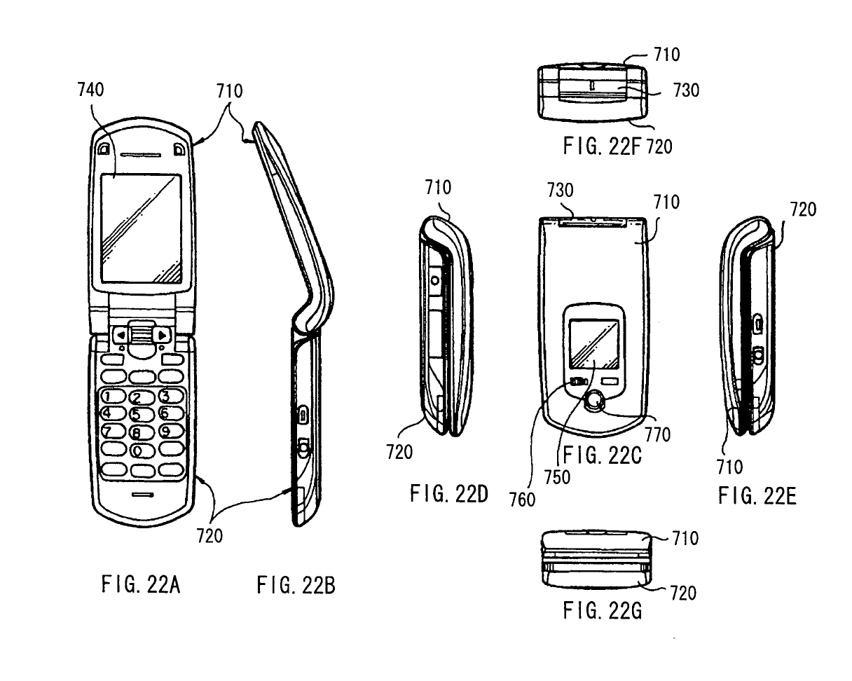

FIGS. 22A to 22G show appearance of a mobile phone using the display device 1 or 2 according to the embodiments and the like. For example, the mobile phone is assembled by connecting an upper housing 710 to a lower housing 720 by a hinge 730, and has a display 740, a sub display 750, a picture light 760, and a camera 770. The display 740 or the sub display 750 is configured of the display device 1 or 2 according to the embodiments and the like.

The present application contains subject matter related to that disclosed in Japanese Priority Patent Application JP 2009-277813 filed in the Japan Patent Office on Dec. 7, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A display device comprising:
a display section including a display region in which a plurality of display pixels are arranged two-dimensionally, the display pixels having first light emitting elements, and a non-display region in which one or multiple adjustment pixels are arranged, each adjustment pixel having a second light emitting element; and
a drive section driving each display pixel based on a video signal, and applying a constant current to the second light emitting element,
wherein the drive section applies a power-supply voltage having a value corresponding to voltage variation in the second light emitting element to each display pixel.

2. The display device according to claim 1,
wherein the drive section compares a voltage of the second light emitting element to a reference voltage to derive voltage variation in the second light emitting element, and thus applies the power-supply voltage having the value corresponding to the voltage variation to each display pixel.

3. The display device according to claim 2,
wherein the drive section applies a constant current to the second light emitting element, the current having a magnitude in correspondence to light emission with white luminance of the second light emitting element.

4. The display device according to claim 1,
wherein the drive section intermittently applies a constant current to the second light emitting element so that a light emission period of the second light emitting element is equal to a light emission period of a first light emitting element in a specified pixel as one display pixel among the plurality of display pixels.

5. The display device according to claim 4,
wherein each adjustment pixel has a switching element connected in series to the second light emitting element, and
the drive section allows the switching element to be turned on or off such that the light emission period of the second light emitting element is equal to the light emission period of the first light emitting element in the specified pixel.

6. The display device according to claim 4,
wherein each display pixel has a first transistor controlling electric current flowing into the first light emitting element, and a second transistor writing a signal voltage corresponding to the video signal to a gate of the first transistor,
each adjustment pixel has a third transistor controlling electric current flowing into the second light emitting element, and a fourth transistor writing a signal voltage corresponding to a fixed signal to a gate of the third transistor, and
the drive section allows the first transistor and the third transistor to be turned on or off at the same timing and allows the second transistor and the fourth transistor to be turned on or off at the same timing in the specified pixel and each adjustment pixel so that the light emission period of the second light emitting element is equal to the light emission period of the first light emitting element in the specified pixel.

7. The display device according to claim 6,
wherein the drive section applies the same first control pulse to the first transistor and the third transistor in the specified pixel and each adjustment pixel, and applies the same second control pulse to the second transistor and the fourth transistor in the specified pixel and each adjustment pixel.

8. The display device according to claim 1,
wherein each display pixel has a first transistor controlling electric current flowing into the first light emitting element, and a second transistor writing a signal voltage corresponding to the video signal to a gate of the first transistor,
one of a source and a drain of the first transistor is connected to the first light emitting element, and
the other of the source and the drain of the first transistor that is not connected to the first light emitting element is connected to a member to be supplied with the power-supply voltage.

9. A method of driving a display device, the display device including a display section having a display region in which a plurality of display pixels are arranged two-dimensionally, the display pixels having first light emitting elements, and a non-display region in which one or multiple adjustment pixels are arranged, each adjustment pixel having a second light emitting element, and including a drive section driving each display pixel based on a video signal and applying a constant current to the second light emitting element, comprising a step of:
applying a power-supply voltage that has a value corresponding to voltage variation in the second light emitting element to each display pixel.

10. An electronic device comprising:
a display device,
wherein the display device includes
a display section having a display region in which a plurality of display pixels are arranged two-dimensionally, the display pixels having first light emitting elements, and a non-display region in which one or multiple adjustment pixels are arranged, each adjustment pixel having a second light emitting element, and
a drive section driving each display pixel based on a video signal, and applying a constant current to the second light emitting element,
wherein the drive section applies a power-supply voltage that has a value corresponding to voltage variation in the second light emitting element, to each display pixel.
